(19) United States
(12) Patent Application Publication
(10) Pub. No.: US 2026/0019902 A1
(43) Pub. Date: Jan. 15, 2026

(54) METHOD AND APPARATUS FOR UE HANDOVER IN IAB NETWORK

(71) Applicant: LENOVO (BEIJING) LIMITED, Beijing (CN)

(72) Inventors: Yibin ZHUO, Shanghai (CN); Mingzeng DAI, Shanghai (CN); Lianhai WU, Beijing (CN); Le YAN, Shanghai (CN); Xiaoying XU, Beijing (CN)

(21) Appl. No.: 18/881,911

(22) PCT Filed: Jul. 8, 2022
(86) PCT No.: PCT/CN2022/104556

§ 371 Date: Jan. 7, 2025

(51) Int. Cl. H04W 36/08; H04L 1/1812; H04L 5/00; H04W 36/14; H04W 76/20

(52) U.S. Cl. CPC H04W 36/08; H04L 1/1812; H04L 5/0053; H04W 36/142; H04W 76/20

(57) ABSTRACT

Embodiments of the present disclosure relate to method and apparatus for handing over a UE in an IAB network. According to some embodiments of the disclosure, a UE may: communicate with a first BS via a wireless network node; receive an RRC reconfiguration message for handing over the UE from the first BS to a second BS together with the wireless network node; and in response to receiving the RRC reconfiguration message, maintain an air interface between the UE and the wireless network node while performing the handover from the first BS to the second BS.

### TECHNICAL FIELD

Embodiments of the present disclosure generally relate to communication technology, and more particularly to handover of user equipment (UE) in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for handling the handover of a UE in the IAB network.

### SUMMARY

Some embodiments of the present disclosure provide a user equipment (UE). The UE may include: a transceiver configured to communicate with a first base station (BS) via a wireless network node; and receive a radio resource control (RRC) reconfiguration message for handing over the UE from the first BS to a second BS together with the wireless network node; and a processor coupled to the transceiver and configured to: in response to receiving the RRC reconfiguration message, maintain an air interface between the UE and the wireless network node while performing the handover from the first BS to the second BS.

In some embodiments of the present disclosure, the RRC reconfiguration message may include a pre-allocated resource for an RRC reconfiguration complete message corresponding to the RRC reconfiguration message, or wherein a resource for random access may not be configured in the RRC reconfiguration message, or both.

In some embodiments of the present disclosure, maintaining the air interface may be performed at a media access control (MAC) entity or a radio link control (RLC) entity or a physical (PHY) layer of the UE.

Some embodiments of the present disclosure provide a first base station (BS). The BS may include: a processor; and a transceiver coupled to the processor. The transceiver may be configured to: transmit, to a second BS, a handover (HO) request message for handing over a user equipment (UE) served by a wireless network node from the first BS to the second BS together with the wireless network node; and receive, from the second BS, a HO request acknowledgement message in response to the HO request message.

Some embodiments of the present disclosure provide a method performed by a user equipment (UE). The method may include: communicating with a first base station (BS) via a wireless network node; receiving a radio resource control (RRC) reconfiguration message for handing over the UE from the first BS to a second BS together with the wireless network node; and in response to receiving the RRC reconfiguration message, maintaining an air interface between the UE and the wireless network node while performing the handover from the first BS to the second BS.

Some embodiments of the present disclosure provide a method performed by a first base station (BS). The method may include: transmitting, to a second BS, a handover (HO) request message for handing over a user equipment (UE) served by a wireless network node from the first BS to the second BS together with the wireless network node; and receiving, from the second BS, a HO request acknowledgement message in response to the HO request message.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example block diagram of a protocol stack for an IAB network in accordance with some embodiments of the present disclosure;

FIG. 3 illustrates an example block diagram of a protocol stack for an IAB network in accordance with some embodiments of the present disclosure;

FIGS. 4-7 illustrate flow charts of exemplary procedures of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, a 1000-time capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (IAB) technology, whose access link(s) and backhaul link(s) may both use wireless transmission solutions to avoid fiber deployment, provides ideas for solving the above problems.

In an IAB network, a wireless network node such as a relay node (RN) or an IAB node or a wireless backhaul node/device can provide wireless access services for UEs. For example, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.” The wireless network node in an IAB network may be stationary or mobile.

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core (5GC) network), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the limited coverage of a high frequency band, and in order to ensure coverage performance of the network, multi-hop networking may be adopted in an IAB network. Taking into account the requirements of service transmission reliability, IAB nodes can support dual connectivity (DC) or multi-connectivity to improve the transmission reliability, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

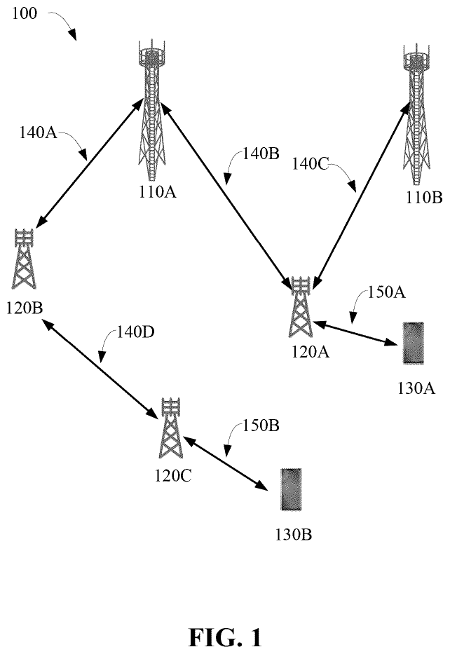

FIG. 1 illustrates a schematic diagram of wireless communication system 100 in accordance with some embodiments of the present disclosure.

As shown in FIG. 1, the wireless communication system 100 may include some base stations (e.g., IAB donor 110A and IAB donor 110B), some IAB nodes (e.g., IAB node 120A, IAB node 120B, and IAB node 120C), and some UEs (e.g., UE 130A and UE 130B). Although a specific number of UEs, IAB nodes, and IAB donors is depicted in FIG. 1, it is contemplated that any number of UEs, IAB nodes, and IAB donors may be included in the wireless communication system 100.

Each of IAB donor 110A, IAB donor 110B, IAB node 120A, IAB node 120B, and IAB node 120C may be directly connected to one or more IAB node(s) in accordance with some other embodiments of the present disclosure. Each of IAB donor 110A, IAB donor 110B, IAB node 120A, IAB node 120B, and IAB node 120C may be directly connected to one or more UEs in accordance with some other embodiments of the present disclosure.

UE 130A and UE 130B may be any type of device configured to operate and/or communicate in a wireless environment. For example, UE 130A and UE 130B may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130A and UE 130B may include a portable wireless communication device, a smart phone, a cellular telephone, a flip phone, a device having a subscriber identity module, a personal computer, a selective call receiver, or any other device that is capable of transmission and receiving communication signals on a wireless network. In some embodiments of the present disclosure, UE 130A and UE 130B may include wearable devices, such as smart watches, fitness bands, optical head-mounted displays, internet-of-things (IoT) devices, or the like. Moreover, UE 130A and UE 130B may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donors 110A and 110B may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donors 110A and 110B may transmit data using an orthogonal frequency division multiple (OFDM) modulation scheme on the DL. UE 130A and UE 130B may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120A can be directly connected to IAB donors 110A and 110B, and IAB node 120B can be directly connected to IAB donor 110A. IAB donors 110A and 110B are parent nodes of IAB node 120A, and IAB donor 110A is a parent node of IAB node 120B. In other words, IAB nodes 120A and 120B are child IAB nodes of IAB donor 110A, and IAB node 120A is also a child IAB node of IAB donor 110B. IAB node 120C can reach IAB donor 110A by hopping through IAB node 120B. IAB node 120B is a parent IAB node of IAB node 120C. In other words, IAB node 120C is a child IAB node of IAB node 120B.

In some other embodiments of the present disclosure, an IAB node may be connected to IAB node 120C so it can reach IAB donor 110A by hopping through IAB node 120C and IAB node 120B. This IAB node and IAB node 120C may be referred to as the descendant IAB nodes of IAB node 120B.

UEs 130A and 130B can be connected to IAB nodes 120A and 120C, respectively. Uplink (UL) packets (e.g., data or signaling) from UE 130A or UE 130B can be transmitted to an IAB donor (e.g., IAB donor 110A or 110B) via one or more IAB nodes, and then transmitted by the IAB donor to a mobile gateway device (such as the user plane function (UPF) in the 5GC). Downlink (DL) packets (e.g., data or signaling) can be transmitted from the IAB donor (e.g., IAB donor 110A or 110B) after being received by the gateway device, and then transmitted to UE 130A or 130B through one or more IAB nodes.

For example, referring to FIG. 1, UE 130A may transmit UL data to IAB donor 110A or 110B or receive DL data therefrom via IAB node 120A. UE 130B may transmit UL data to IAB donor 110A or receive DL data therefrom via IAB node 120C and IAB node 120B.

In an IAB deployment such as the wireless communication system 100, the radio link between an IAB donor (e.g., IAB donor 110A or 110B in FIG. 1) and an IAB node or between two IAB nodes may be referred to as a backhaul link (BL). The radio link between an IAB donor (e.g., IAB donor 110A or 110B in FIG. 1) and a UE or between an IAB node and a UE may be referred to as an access link (AL). For example, in FIG. 1, radio links 140A to 140D are BLs and radio links 150A and 150B are ALs.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

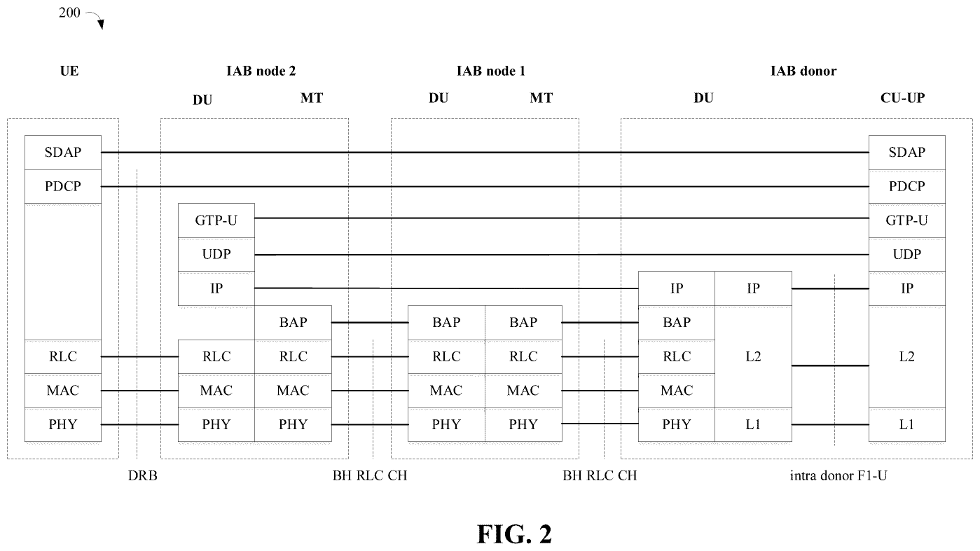

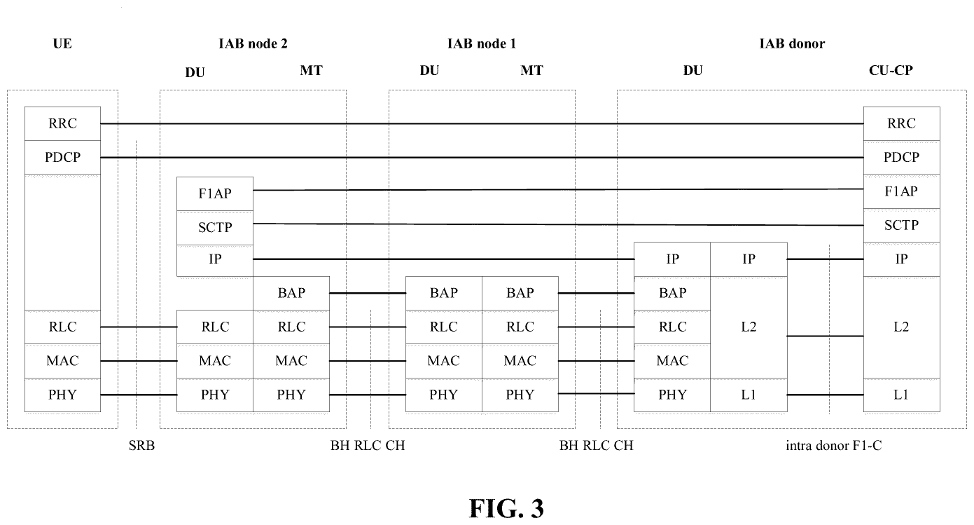

FIG. 2 illustrates an example block diagram of user plane (UP) protocol stack 200 for an IAB network according to some embodiments of the present disclosure. FIG. 3 illustrates an example block diagram of control plane (CP) protocol stack 300 for an IAB network according to some embodiments of the present disclosure. In FIGS. 2 and 3, a UE may be connected to an IAB donor via IAB node 2 and IAB node 1. In some other embodiments of the present disclosure, a UE may be connected to an IAB donor via more or less IAB nodes.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, an SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purposes. For example, the sequences of some of the protocol layers in the protocol stacks of FIGS. 2 and 3 may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2.

In some scenarios, a wireless network node (e.g., stationery or mobile) can be migrated (or handed over) from one BS (source BS or source IAB donor) to another BS (target BS or target IAB donor), or a wireless network node can be migrated to another parent node under another BS. For example, referring back to FIG. 1, IAB node 120C or IAB node 120B may be migrated from IAB donor 110A to IAB donor 110B.

In some embodiments, the descendent nodes (e.g., the UE(s) served by the wireless network node) of the wireless network node may also migrate to the target BS. For example, the UE(s) may migrate to the target BS together with the wireless network node and may still be served by the wireless network node after the migration. This may also be referred to as group mobility.

Embodiments of the present disclosure provide solutions for handling the handover (or migration) of a UE served by a wireless network node when the UE is handed over together with the wireless network node. For example, enhanced solutions for handing over the UE are proposed. For example, solutions for minimizing the impact of the handover on the UE are proposed. More details on the embodiments of the present disclosure will be illustrated in the following text in combination with the appended drawings.

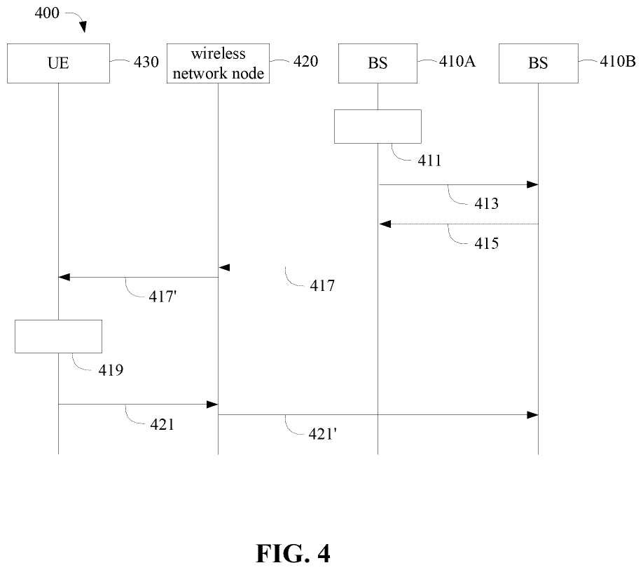

FIG. 4 illustrates a flow chart of exemplary procedure 400 for wireless communications in accordance with some embodiments of the present disclosure. Details described in all of the foregoing embodiments of the present disclosure are applicable for the embodiments shown in FIG. 4. For example, BS 410A and BS 410B may function as the IAB donors as described above, and wireless network node 420 may function as the IAB nodes as described above.

Referring to FIG. 4, UE 430 may communicate with BS 410A (e.g., a cell of BS 510A) via wireless network node 420. In operation 411, BS 410A (source BS) may determine to hand over wireless network node 420 to a target cell (e.g., a cell of BS 410B) or a target BS (e.g., BS 410B).

In some embodiments of the present disclosure, at least one UE (e.g., UE 430) served by wireless network node 420 may also be handed over to the target cell or the target BS. For example, BS 410A (e.g., CU of BS 410A) may trigger the handover (HO) of UE 430 and may transmit a HO request message to BS 410B (e.g., CU of BS 410B) in operation 413.

In some examples, for each of the at least one UE served by wireless network node 420, BS 410A may transmit a corresponding HO request message to BS 410B. In some examples, the HO request(s) for the at least one UE served by wireless network node 420 may bundled with the HO request for wireless network node 420 (e.g., MT of wireless network node 420), which is also referred to as group mobility.

In some embodiments of the present disclosure, the HO request for UE 430 may indicate (e.g., by including an indication) that a simplified HO procedure is supported at UE 430. A simplified HO procedure may be different from a normal UE HO procedure. The indication can be used to differentiate the simplified HO procedure and the normal UE HO.

For example, during a normal HO procedure, a UE may perform random access to the target cell, perform a MAC reset, refresh of security and reestablishment of RLC and PDCP, and stop the beam failure detection and recovery procedure. As will be described in detail in the following text, a simplified HO procedure may maintain an air interface between a UE and its serving wireless network node (e.g., between the UE and the serving cell of the wireless network node), thereby minimizing the impact of the handover on the UE. For example, as the serving wireless network node does not change during the handover of a UE together with the migration of its serving wireless network node, some configurations (e.g., lower layer configuration(s) such as PHY, MAC and/or RLC configurations, or serving beam) may be (partially) reusable after the handover. The simplified HO procedure may take this into consideration and introduce enhancements on the UE HO procedure.

In response to receiving the HO request message, BS 410B (e.g., CU of BS 410B) may perform admission control for UE 430 and may transmit a HO request acknowledgement message to BS 410A in operation 415. The HO request acknowledgement message may include an RRC reconfiguration message for handing over UE 430 together with (or associated with) wireless network node 420.

In some embodiments of the present disclosure, the RRC reconfiguration message may indicate (e.g., explicitly or implicitly) to maintain an air interface between UE 430 and wireless network node 420. In some embodiments of the present disclosure, maintaining the air interface may be performed at a MAC entity, an RLC entity, or a PHY layer of UE 430.

In some embodiments of the present disclosure, maintaining the air interface between UE 430 and wireless network node 420 may include at least one of the following: not resetting a MAC entity of UE 430; not reestablishing an RLC entity of UE 430; or not performing random access with wireless network node 420 (e.g., to the cell of BS 410B or to the target cell).

In some embodiments of the present disclosure, the RRC reconfiguration message may include an indication to maintain the air interface. For example, in some embodiments, the RRC reconfiguration message may include an information element (IE) for MAC reset or an IE for RLC reestablishment (e.g., resetMAC IE, re-establishRLC IE, or resetMAC/re-establishRLC IE) to indicate whether the MAC entity should be reset or not, or whether the RLC entity should be reestablished or not. For example, the IE may be a Boolean type having a value of “TRUE” or “FALSE”. In some other embodiments, an IE(s) for no MAC reset or no RLC reestablishment (e.g., not-resetMAC IE, not-re-establishRLC IE, or not-resetMAC/re-establishRLC IE) may be employed.

In some embodiments of the present disclosure, whether or not to maintain the air interface between UE 430 and wireless network node 420 may be implicitly indicated in the RRC reconfiguration message. For example, in the case that the RRC reconfiguration message includes a pre-allocated resource for an RRC reconfiguration complete message corresponding to the RRC reconfiguration message, the RRC reconfiguration message does not configure a resource(s) for random access, or both, whereby the RRC reconfiguration message may implicitly indicate that the air interface between UE 430 and wireless network node 420 should be maintained. For example, the above case may indicate that UE 430 should not perform random access with wireless network node 420 (e.g., to the cell of BS 410B or to the target cell).

According to the above embodiments, the description for an RRC reconfiguration (e.g., the purpose of an RRC reconfiguration procedure) can include the following (note that the wireless network node in the following text may be an IAB node, mobile or stationary):
to modify an RRC connection, for example, to establish/modify/release radio bearers (RBs), to perform reconfiguration with sync, to setup/modify/release measurements, to add/modify/release secondary cells (SCells) and cell groups, to add/modify/release conditional handover configuration, to add/modify/release conditional primary secondary cells (PSCell) change configuration, to perform UE mobility associated with the serving wireless network node (in this case, MAC may not be reset and/or RLC may not be re-established and/or UE does not perform random access to the target cell). As part of the procedure, non-access stratum (NAS) dedicated information may be transferred from the network to the UE.

According to the above embodiments, an RRC reconfiguration to perform reconfiguration with sync may include, but is not limited to, the following (note that the wireless network node in the following text may be an IAB node, mobile or stationary):
reconfiguration with sync and security key refresh, involving random access (RA) to the primary secondary cell (PCell)/PSCell, MAC reset, refresh of security and re-establishment of RLC and PDCP triggered by explicit L2 indicators; or for a UE served by a wireless network node, MAC may not be reset and/or RLC may not be re-established and/or UE does not perform random access to the target cell.

In some embodiments, whether to indicate (e.g., explicitly or implicitly) to maintain the air interface or not may be based on whether the UE is handed over together with its serving wireless network node or not. In some embodiments, whether to indicate (e.g., explicitly or implicitly) to maintain the air interface or not may be based on whether a simplified HO procedure is supported at a UE or not.

In response to receiving the HO request acknowledgement message, BS 410A (e.g., CU of BS 410A) may transmit a UE context modification request message to wireless network node 420 (e.g., DU of wireless network node 420) in operation 417. The UE context modification request message may include the RRC reconfiguration message from BS 410B. In operation 417′, wireless network node 420 may forward the RRC reconfiguration message to UE 430.

In operation 419, in response to receiving the RRC reconfiguration message, UE 430 may maintain an air interface between UE 430 and wireless network node 420 while performing the handover from BS 410A to BS 410B (e.g., from the source cell to the target cell). For example, as described above, in some embodiments, UE 430 may not reset the MAC entity, may not reestablish the RLC entity, or may not perform random access with wireless network node 420 (e.g., to the cell of BS 410B or to the target cell).

In some embodiments of the present disclosure, UE 430 may still perform a MAC reset or RLC reestablishment during the handover of UE 430 or migration of wireless network node 420. However, enhancements of the UE behavior on its MAC layer or MAC entity can be introduced.

For example, in some embodiments of the present disclosure, maintaining the air interface between UE 430 and wireless network node 420 may include at least one of the following: (a) not initializing a token bucket parameter or transmittable data amount (e.g., Bj as specified in 3GPP specifications) for each logical channel (e.g., logical channels of UE 430 associated with wireless network node 420) during a logical channel prioritization procedure; (b) not resetting new data indicators (NDIs) for uplink hybrid automatic repeat request (HARQ) processes at UE 430; (c) not cancelling any triggered buffer status reporting (BSR) procedure; (d) not cancelling any triggered timing advance reporting procedure; (e) not cancelling any triggered recommended bit rate query procedure; or (f) not flushing soft buffers for DL HARQ processes. To put another way, in the case that a reset of the MAC entity is requested by an upper layer (e.g., the RRC layer), the MAC entity of UE 430 may perform at least one of operations (a)-(f).

In some embodiments, operation (a) may include not initializing the token bucket parameter to zero. Operation (a) is advantageous because the UL transmission at UE 430 may be still processed between UE 430 and wireless network node 420 during the handover of UE 430 together with wireless network node 420. It would be unnecessary to set the token bucket parameter to zero and the MAC entity can keep the value as it is during the handover.

In some embodiments, operation (b) may include not set the NDIs for all UL HARQ processes to the value 0. Operation (b) is advantageous because for each UL HARQ process, the UL transmission may still be processed between UE 430 and wireless network node 420 during the handover of UE 430 together with wireless network node 420. It would be unnecessary to set the token bucket parameter to zero and the MAC entity can keep the value as it is during the handover. The next transmission for a specific TB may be the initial transmission or a retransmission. It would be unnecessary to set the NDI for the corresponding HARQ process to 0.

Operation (c) is advantageous because the UL buffer in UE 430 has not been flushed during the handover, and UE 430 does not change the serving wireless network node (e.g., IAB-DU), and thus it would be unnecessary to cancel any triggered BSR procedure in the target cell.

Operation (d) is advantageous because UE 430 does not change the serving wireless network node (e.g., IAB-DU), and thus the timing relation between UE 430 and wireless network node 420 may not need to be updated during the handover. Therefore, it would be unnecessary to cancel any triggered timing advance reporting procedure in the target cell.

Operation (e) is advantageous because UE 430 does not change the serving wireless network node (e.g., IAB-DU), and thus the recommended bit rate for the physical layer may not need to be updated during the handover. Therefore, it would be unnecessary to cancel any triggered recommended bit rate query procedure in the target cell.

Operation (f) is advantageous because for each DL HARQ process, the DL transmission may be still processed between UE 430 and wireless network node 420 during the handover of UE 430 together with wireless network node 420. The next transmission for a specific TB may be the initial transmission or a retransmission. It would be unnecessary to flush the soft buffer. Flushing the soft buffer may however have some impacts on the reliability of the DL transmission.

In some embodiments of the present disclosure, enhancements of the UE behavior on its MAC layer or MAC entity can be introduced. Such enhancements can be applied to various scenarios including the scenario where UE 430 performs a MAC reset during the handover of UE 430 or migration of wireless network node 420, or a scenario where UE 430 does not perform a MAC reset during the handover of UE 430 or migration of wireless network node 420.

For example, in some embodiments of the present disclosure, in response to receiving the RRC reconfiguration message for handing over UE 430 together with wireless network node 420, the MAC entity of UE 430 may perform at least one of the following:
stop, if any, ongoing random access procedure;
stop timers for random access (RA), for example, a contention resolution timer for RA (e.g., ra-ContentionResolutionTimer as specified in 3GPP specifications);
discard explicitly signaled contention-free random access resources for 4-step RA type and 2-step RA type, if any;
flush Msg3 buffer;
flush MsgA buffer;
cancel, if any, triggered scheduling request procedure;
cancel, if any, triggered power headroom reporting procedure;
cancel, if any, triggered configured uplink grant confirmation; or
release, if any, temporary cell radio network temporary identifier (C-RNTI).

At least one of the above operations may be performed regardless of a MAC reset is indicated to be performed or not. Or put another way, in the case that UE 430 performs a MAC reset (e.g., MAC reset is requested by an upper layer) during the handover of UE 430 together with wireless network node 420, at least one of the above operations may be performed by the MAC entity of UE 430. For example, in the case that the cell ID of wireless network node 420 is changed during the handover, UE 430 may cancel any triggered power headroom reporting procedure. In the case that UE 430 does not perform a MAC reset (e.g., a MAC reset is not requested by an upper layer) during the handover of UE 430 together with wireless network node 420, at least one of the above operations may be performed by the MAC entity of UE 430.

In some examples, UE 430 may determine to maintain the air interface when it is handed over together with its serving wireless network node. In some examples, UE 430 may determine to maintain the air interface based on an explicit or implicit indication of the RRC reconfiguration message.

In operation 421, UE 430 may transmit an RRC reconfiguration complete message to wireless network node 420. In operation 421′, wireless network node 420 may transmit a UL RRC message transfer message to BS 410B to convey the received RRC reconfiguration complete message.

It should be appreciated by persons skilled in the art that the sequence of the operations in exemplary procedure 400 may be changed and some of the operations in exemplary procedure 400 may be eliminated or modified, without departing from the spirit and scope of the disclosure.

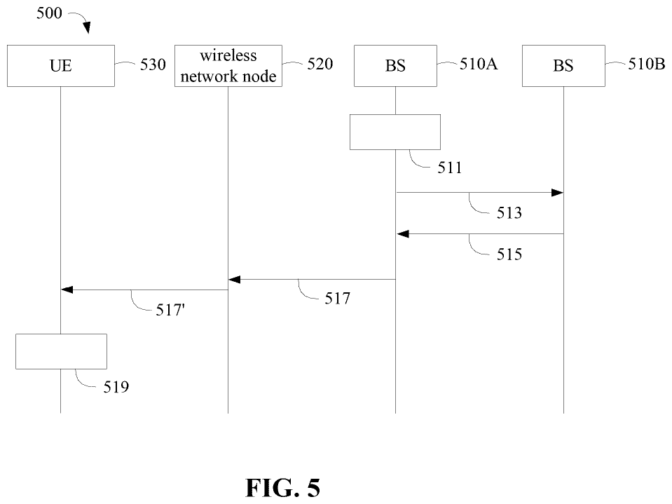

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5. For example, BS 510A and BS 510B may function as the IAB donors as described above, and wireless network node 520 may function as the IAB nodes as described above.

Referring to FIG. 5, UE 530 may communicate with BS 510A (e.g., a cell of BS 510A) via wireless network node 520. In some embodiments of the present disclosure, a beam failure detection and recovery procedure may be performed at UE 530. For example, UE 530 (e.g., the MAC entity) may start a timer for beam failure detection (BFD) (e.g., beamFailureDetectionTimer as specified in 3GPP specifications) when a beam failure instance indication is received. For example, UE 530 (e.g., the MAC entity) may increment a counter for beam failure instance (e.g., BFI_COUNTER as specified in 3GPP specifications) when a beam failure instance indication is received. UE 530 may trigger a beam failure recovery (BFR) procedure under certain conditions including, for example, when the counter for beam failure instance reaches a threshold.

In operation 511, BS 510A (source BS) may determine to hand over wireless network node 520 to a target cell (e.g., a cell of BS 510B) or a target BS (e.g., BS 510B).

In some embodiments of the present disclosure, at least one UE (e.g., UE 530) served by wireless network node 520 may also be handed over to the target cell or the target BS. For example, BS 510A (e.g., CU of BS 510A) may trigger the HO of UE 530 and may transmit a HO request message to BS 510B (e.g., CU of BS 510B) in operation 513.

In some examples, for each of the at least one UE served by wireless network node 520, BS 510A may transmit a corresponding HO request message to BS 510B. In some examples, the HO request(s) for the at least one UE served by wireless network node 520 may bundled with the HO request for wireless network node 520 (e.g., MT of wireless network node 520), which is also referred to as group mobility.

In some embodiments of the present disclosure, the HO request for UE 530 may indicate (e.g., by including an indication) that a simplified HO procedure is supported at UE 530. The above descriptions regarding the simplified HO procedure may also apply here and thus are omitted herein.

In response to receiving the HO request message, BS 510B (e.g., CU of BS 510B) may perform admission control for UE 530 and may transmit a HO request acknowledgement message to BS 510A in operation 515. The HO request acknowledgement message may include an RRC reconfiguration message for handing over UE 530 together with (or associated with) wireless network node 520.

In some embodiments of the present disclosure, the RRC reconfiguration message may indicate (e.g., explicitly or implicitly) to maintain an air interface between UE 530 and wireless network node 520. The above descriptions regarding maintaining the air interface may also apply here and thus are omitted herein.

In response to receiving the HO request acknowledgement message, BS 510A (e.g., CU of BS 510A) may transmit a UE context modification request message to wireless network node 520 (e.g., DU of wireless network node 520) in operation 517. The UE context modification request message may include the RRC reconfiguration message from BS 510B. In operation 517′, wireless network node 520 may forward the RRC reconfiguration message to UE 530.

In operation 519, in response to receiving the RRC reconfiguration message, UE 530 may maintain an air interface between UE 530 and wireless network node 520 while performing the handover from BS 510A to BS 510B. For example, as described above, in some embodiments, UE 530 may not reset the MAC entity, may not reestablish the RLC entity, or may not perform random access with wireless network node 520 (e.g., to the cell of BS 510B or to the target cell). For example, as described above, in some embodiments, UE 530 may perform at least one of operations (a)-(f).

In some embodiments of the present disclosure, enhancements of the UE behavior on the beam failure detection and recovery procedure can be introduced.

For example, as the serving wireless network node does not change during the handover of a UE (e.g., UE 530) together with the migration of its serving wireless network node (e.g., wireless network node 520), the serving beam of the UE for the source BS (e.g., BS 510A) or source cell (e.g., the cell of BS 510A) may be the same as that for the target BS (e.g., BS 510B) or target cell (e.g., the cell of BS 510B). In some embodiments, the serving beam may refer to the serving synchronization signal block(s) (SSB(s)) or channel state information reference signal(s) (CSI-RS(s)) for beam failure detection and recovery. In this scenario, maintaining the air interface between UE 530 and wireless network node 520 may include at least one of the following: use the same serving beam for beam failure detection and recovery in the target BS (or cell) as in the source BS (or cell); suspending or not stopping the timer for BFD during the handover of UE 530; maintaining or not resetting the counter for beam failure instance during the handover of UE 530; cancelling any triggered BFR procedure with BS 510A; or triggering a BFR procedure with BS 510B in response to connecting to BS 510B in the case that a triggered BFR procedure with BS 510A is not cancelled before the handover of UE 530 or there is an ongoing BFR procedure with BS 510A before the handover of UE 530. In some embodiments, a serving cell of UE 530 may be configured with more than one serving beam (e.g., two BFD-RS sets), the above behaviors may be applied to each serving beam of the serving cell.

For example, if a BFR has not been triggered in the source cell (e.g., BS 510A), or UE 530 still performs the beam failure detection for the source cell, or the serving beam has not been declared a failure when the handover occurs, UE 530 (e.g., the MAC entity) may maintain the counter for beam failure instance and the timer for BFD during the handover. In some examples, UE 530 (e.g., the MAC entity) may suspend or not stop the timer for BFD and not reset the counter for beam failure instance during the handover.

For example, if a BFR has been triggered and not cancelled in the source cell (e.g., BS 510A), or there is an ongoing BFR procedure in the source cell (e.g., BS 510A), or the serving beam has been declared a failure when the handover occurs (e.g., the RRC reconfiguration message or HO command may be received before triggering the BFR procedure), UE 530 (e.g., the MAC entity) may maintain or not reset the counter for beam failure instance. UE 530 (e.g., the MAC entity) may maintain, not stop or suspend the timer for BFD during the handover. In some examples, UE 530 may cancel the triggered BFR procedure in the source cell (e.g., with BS 510A). In some examples, in response to UE 530 connecting the target cell (e.g., with BS 510B), UE 530 may trigger a BFR procedure in the target cell. For instance, for a special cell (SpCell) (e.g., the BFR is triggered for an SpCell), UE 530 may trigger a random access procedure. For an SCell (e.g., the BFR is triggered for an SCell), UE 530 may transmit a BFR MAC control element (CE).

As described above, the RRC reconfiguration message may indicate (e.g., explicitly or implicitly) to maintain an air interface between UE 530 and wireless network node 520. In some embodiments of the present disclosure, the explicit indication may refer to that an indication in the RRC reconfiguration message indicates that the serving beam of UE 530 for the source BS (e.g., BS 510A) or source cell (e.g., the cell of BS 510A) is the same as that for the target BS (e.g., BS 510B) or target cell (e.g., the cell of BS 510B). UE 530 may determine to maintain the air interface or not (e.g., performing the above operations regarding the beam failure detection and recovery procedure) based on the indication. In some embodiments of the present disclosure, an implicit indication may be implemented as follows. For example, the RRC reconfigure message may include beam information configured by BS 510B. UE 530 may determine whether the serving beam of UE 530 for the source BS (e.g., BS 510A) or source cell (e.g., the cell of BS 510A) is the same as that for the target BS (e.g., BS 510B) or target cell (e.g., the cell of BS 510B) based on the beam information. UE 530 may determine whether to maintain the air interface or not (e.g., performing the above operations regarding the beam failure detection and recovery procedure) based on the determination of whether the serving beam is changed or not. In some embodiments of the present disclosure, UE 530 may assume that the air interface should be maintained (e.g., performing the above operations regarding the beam failure detection and recovery procedure) in the case of group mobility.

It should be appreciated by persons skilled in the art that the sequence of the operations in exemplary procedure 500 may be changed and some of the operations in exemplary procedure 500 may be eliminated or modified, without departing from the spirit and scope of the disclosure.

In some embodiments of the present disclosure, if a BS knows that a serving beam of a UE has been declared a failure, it would be advantageous for the BS to inform the beam information to the target BS when the BS decides to handover the UE to the target cell.

For example, referring again to FIG. 5, the HO request message transmitted in operation 513 may include information regarding whether a serving beam of UE 530 for BS 510A or the source cell (e.g., the cell of BS 510A) has been declared a failure or not; or a candidate beam (e.g., serving SSB(s) and/or CSI-RS(s)) applicable for BS 510B or the target cell (e.g., the cell of BS 510B). The information can be for the SCell or SpCell. In the case that the serving beam of UE 530 for BS 510A or the source cell has been declared a failure, BS 510B may reconfigure a beam and include the reconfiguration information in the RRC reconfiguration message to UE 530. The reconfigured beam may be based on the candidate beam.

It should be appreciated by persons skilled in the art that the above embodiments regarding the beam information indication between the BSs may be applied to any types of HO procedure, including for example, exemplary procedure 500, a normal HO procedure, a HO procedure where a UE directly connects to a source BS, a HO procedure where the source cell and target cell are co-located and so on.

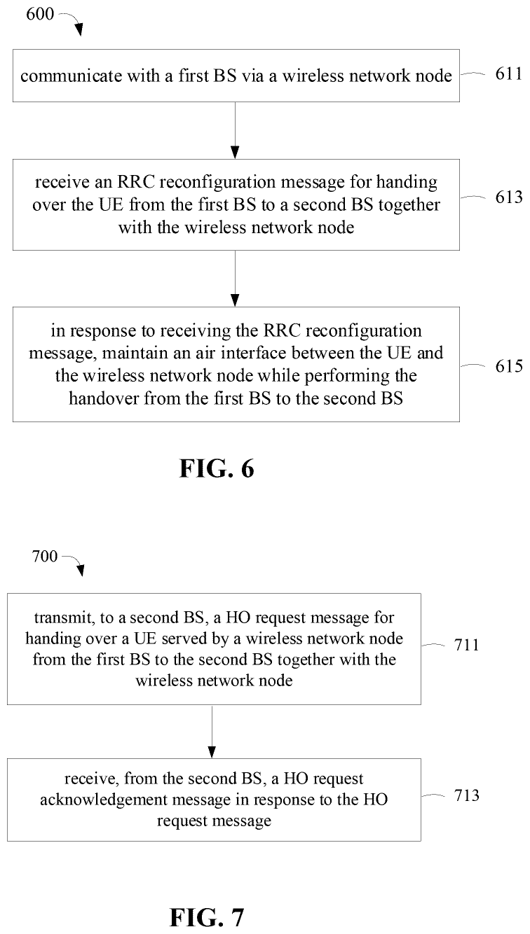

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6.

Referring to FIG. 6, in operation 611, a UE may communicate with a first BS (e.g., source BS) via a wireless network node. In operation 613, the UE may receive an RRC reconfiguration message for handing over the UE from the first BS to a second BS (e.g., target BS) together with the wireless network node. In some embodiments, the first BS and second BS may be an IAB donor and the wireless network node may be an IAB node.

In operation 615, the UE may, in response to receiving the RRC reconfiguration message, maintain an air interface between the UE and the wireless network node while performing the handover from the first BS to the second BS. The air interface between the UE and the wireless network node may refer to the air interface between UE and the serving cell of the wireless network node.

The previous descriptions regarding the RRC reconfiguration message and maintaining the air interface may apply here.

For example, in some embodiments of the present disclosure, the RRC reconfiguration message may include an indication to maintain the air interface between the UE and the wireless network node.

For example, in some embodiments of the present disclosure, the RRC reconfiguration message may include a pre-allocated resource for an RRC reconfiguration complete message corresponding to the RRC reconfiguration message, wherein a resource for random access is not configured in the RRC reconfiguration message, or both.

For example, in some embodiments of the present disclosure, maintaining the air interface between the UE and the wireless network node may include at least one of the following: not resetting a MAC entity of the UE; not reestablishing an RLC entity of the UE; or not performing random access with the wireless network node.

For example, in some embodiments of the present disclosure, maintaining the air interface between the UE and the wireless network node may include at least one of the following: not initializing a token bucket parameter (e.g., initializing to zero) for each logical channel during a logical channel prioritization procedure; not resetting new data indicators (e.g., setting to zero) for uplink HARQ processes; not cancelling any triggered buffer status reporting procedure; not cancelling any triggered timing advance reporting procedure; not cancelling any triggered recommended bit rate query procedure; or not flushing soft buffers for downlink HARQ processes.

For example, in some embodiments of the present disclosure, the indication may indicate that the serving beam of the UE for the first BS is the same as that for the second BS.

For example, in some embodiments of the present disclosure, maintaining the air interface between the UE and the wireless network node may include performing at least one of the following: using the serving beam for beam failure detection and recovery in the first BS as that in the second BS; suspending or not stopping a timer for BFD during the handover; maintaining or not resetting a counter for beam failure instance during the handover; cancelling any triggered BFR procedure with the first BS; or triggering a BFR procedure with the second BS in response to connecting to the second BS in the case that a triggered BFR procedure with the first BS is not cancelled before the handover or there is an ongoing BFR procedure with the first BS before the handover.

For example, in some embodiments of the present disclosure, maintaining the air interface is performed at a MAC entity or an RLC entity or a PHY layer of the UE.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7.

Referring to FIG. 7, in operation 711, a first BS (e.g., source BS) may transmit, to a second BS (e.g., target BS), a HO request message for handing over a UE served by a wireless network node from the first BS to the second BS together with the wireless network node. In some embodiments, the first BS and second BS may be an IAB donor and the wireless network node may be an IAB node.

In operation 713, the first BS may receive, from the second BS, a HO request acknowledgement message in response to the HO request message.

The previous descriptions regarding the HO request message may apply here.

For example, in some embodiments of the present disclosure, the HO request message may indicate that a simplified HO procedure is supported at the UE. In some embodiments, during the simplified HO procedure, the UE may maintain an air interface between the UE and the wireless network node. The previous descriptions regarding maintaining the air interface may apply here.

In some embodiments of the present disclosure, the HO request acknowledgement message may include an RRC reconfiguration message for handing over the UE from the first BS to the second BS. The previous descriptions regarding the RRC reconfiguration message may apply here.

For example, the RRC reconfiguration message may include an indication to maintain an air interface between the UE and the wireless network node. For example, the RRC reconfiguration message may include a pre-allocated resource for an RRC reconfiguration complete message corresponding to the RRC reconfiguration message, wherein a resource for random access is not configured in the RRC reconfiguration message, or both.

For example, in some embodiments of the present disclosure, the indication may indicate at least one of the following: the UE not resetting a MAC entity of the UE; the UE not reestablishing an RLC entity of the UE; or the UE not performing random access with the wireless network node.

For example, in some embodiments of the present disclosure, the indication may indicate at least one of the following: the UE not initializing a token bucket parameter for each logical channel during a logical channel prioritization procedure; the UE not resetting new data indicators for uplink HARQ processes; the UE not cancelling any triggered buffer status reporting procedure; the UE not cancelling any triggered timing advance reporting procedure; the UE not cancelling any triggered recommended bit rate query procedure; or the UE not flushing soft buffers for downlink HARQ processes.

For example, in some embodiments of the present disclosure, the indication may indicate that the serving beam of the UE for the first BS is the same as that for the second BS.

For example, in some embodiments of the present disclosure, the HO request message may include at least one of: information regarding whether a serving beam of the UE for the first BS has been declared a failure or not; or a candidate beam applicable for the target BS.

It should be appreciated by persons skilled in the art that the sequence of the operations in exemplary procedure 700 may be changed and some of the operations in exemplary procedure 700 may be eliminated or modified, without departing from the spirit and scope of the disclosure.

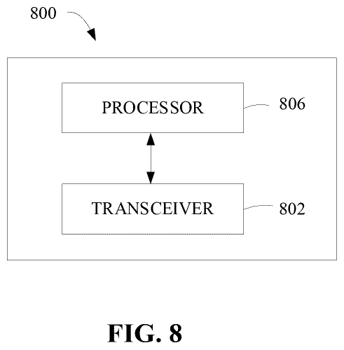

FIG. 8 illustrates a block diagram of exemplary apparatus 800 according to some embodiments of the present disclosure.

As shown in FIG. 8, the apparatus 800 may include at least one processor 806 and at least one transceiver 802 coupled to the processor 806. The apparatus 800 may be a wireless network node (e.g., an IAB node), a BS (e.g., an IAB donor, IAB donor-CU, or IAB donor-DU), or a UE.

Although in this figure elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UEs described in FIGS. 1-7. In some embodiments of the present application, the apparatus 800 may be a BS. The transceiver 802 and the processor 806 may interact with each other so as to perform the operations with respect to the BSs, the IAB donors, IAB donor-CUs, or IAB donor-DUs described in FIGS. 1-7. In some embodiments of the present application, the apparatus 800 may be a wireless network node. The transceiver 802 and the processor 806 may interact with each other so as to perform the operations with respect to the wireless network nodes or the IAB nodes (mobile or stationary) described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UEs as described above. For example, the computer-executable instructions, when executed, cause the processor 806 interacting with transceiver 802 to perform the operations with respect to the UEs described in FIGS. 1-7.

In some embodiments of the present disclosure, the non-transitory computer-readable medium may have stored thereon computer-executable instructions to cause the processor 806 to implement the method with respect to the BSs, the IAB donors, IAB donor-CUs, or IAB donor-DUs as described above. For example, the computer-executable instructions, when executed, cause the processor 806 interacting with transceiver 802 to perform the operations with respect to the BSs, the IAB donors, IAB donor-CUs, or IAB donor-DUs described in FIGS. 1-7.

For example, in some embodiments of the present disclosure, the thereon non-transitory computer-readable medium may have stored computer-executable instructions to cause the processor 806 to implement the method with respect to the wireless network node or the IAB nodes (mobile or stationary) as described above. For example, the computer-executable instructions, when executed, cause the processor 806 interacting with transceiver 802 to perform the operations with respect to the wireless network nodes or the IAB nodes (mobile or stationary) described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover,” “path switch,” and “migration” may be used interchangeably. The terms “includes,” “including,” or any other variations thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
communicate with a first base station (BS) via a wireless network node;
receive a radio resource control (RRC) reconfiguration message for handing over the UE from the first BS to a second BS together with the wireless network node; and
in response to receiving the RRC reconfiguration message, maintain an air interface between the UE and the wireless network node while performing the handover from the first BS to the second BS.

2. The UE of claim 1, wherein the RRC reconfiguration message includes an indication to maintain the air interface between the UE and the wireless network node.

3. The UE of claim 1, wherein the at least one processor is configured to cause the UE to maintain the air interface between the UE and the wireless network node by:
not resetting a media access control (MAC) entity of the UE;
not reestablishing a radio link control (RLC) entity of the UE; or
not performing random access with the wireless network node.

4. The UE of claim 1, wherein the at least one processor is configured to cause the UE to maintain the air interface between the UE and the wireless network node by:
not initializing a token bucket parameter for each logical channel during a logical channel prioritization procedure;
not resetting new data indicators for uplink hybrid automatic repeat request (HARQ) processes;
not cancelling any triggered buffer status reporting procedure;
not cancelling any triggered timing advance reporting procedure;
not cancelling any triggered recommended bit rate query procedure; or
not flushing soft buffers for downlink HARQ processes.

5. The UE of claim 2, wherein the indication indicates that a serving beam of the UE for the first BS is the serving beam for the second BS.

6. The UE of claim 5, wherein the at least one processor is configured to cause the UE to maintain the air interface between the UE and the wireless network node by:
using the serving beam for beam failure detection and recovery in the first BS and in the second BS;
suspending or not stopping a timer for beam failure detection (BFD) during the handover;
maintaining or not resetting a counter for beam failure instance during the handover;
cancelling any triggered beam failure recovery (BFR) procedure with the first BS; or
triggering a BFR procedure with the second BS in response to connecting to the second BS in the case that a triggered BFR procedure with the first BS is not cancelled before the handover or there is an ongoing BFR procedure with the first BS before the handover.

7. A first base station (BS) for wireless communication, comprising:
at least one memory; and
at least one processor coupled with the at least one memory and configured to cause the first BS to:
transmit, to a second BS, a handover (HO) request message for handing over a user equipment (UE) served by a wireless network node from the first BS to the second BS together with the wireless network node; and
receive, from the second BS, a HO request acknowledgement message in response to the HO request message.

8. The first BS of claim 7, wherein the HO request message indicates that a simplified HO procedure is supported at the UE, and during the simplified HO procedure, the UE maintains an air interface between the UE and the wireless network node.

9. The first BS of claim 7, wherein the HO request acknowledgement message includes a radio resource control (RRC) reconfiguration message for handing over the UE from the first BS to the second BS; and
wherein the RRC reconfiguration message includes an indication to maintain an air interface between the UE and the wireless network node.

10. The first BS of claim 7, wherein the HO request acknowledgement message includes a radio resource control (RRC) reconfiguration message for handing over the UE from the first BS to the second BS; and
wherein the RRC reconfiguration message includes a pre-allocated resource for an RRC reconfiguration complete message corresponding to the RRC reconfiguration message, wherein a resource for random access is not configured in the RRC reconfiguration message, or both.

11. The first BS of claim 9, wherein the indication indicates at least one of the following:
the UE not resetting a media access control (MAC) entity of the UE;
the UE not reestablishing a radio link control (RLC) entity of the UE; or
the UE not performing random access with the wireless network node.

12. The first BS of claim 9, wherein the indication indicates at least one of the following:
the UE not initializing a token bucket parameter for each logical channel during a logical channel prioritization procedure;
the UE not resetting new data indicators for uplink hybrid automatic repeat request (HARQ) processes;
the UE not cancelling any triggered buffer status reporting procedure;
the UE not cancelling any triggered timing advance reporting procedure;
the UE not cancelling any triggered recommended bit rate query procedure; or
the UE not flushing soft buffers for downlink HARQ processes.

13. The first BS of claim 9, wherein the indication indicates that a serving beam of the UE for the first BS is the serving beam for the second BS.

14. The first BS of claim 7, wherein the HO request message includes at least one of:
information regarding whether a serving beam of the UE for the first BS has been declared a failure or not; or
a candidate serving beam applicable for the target BS.

15. A method performed by a user equipment (UE), the method comprising:
communicating with a first base station (BS) via a wireless network node;
receiving a radio resource control (RRC) reconfiguration message for handing over the UE from the first BS to a second BS together with the wireless network node; and
in response to receiving the RRC reconfiguration message, maintaining an air interface between the UE and the wireless network node while performing the handover from the first BS to the second BS.

16. The method of claim 15, wherein the RRC reconfiguration message includes an indication to maintain the air interface between the UE and the wireless network node.

17. The UE of claim 16, wherein the indication indicates that a serving beam of the UE for the first BS is the serving beam for the second BS.

18. The method of claim 15, wherein maintaining the air interface between the UE and the wireless network node comprises:
not resetting a media access control (MAC) entity of the UE;
not reestablishing a radio link control (RLC) entity of the UE; or
not performing random access with the wireless network node.

19. The method of claim 15, wherein maintaining the air interface between the UE and the wireless network node comprises:
not initializing a token bucket parameter for each logical channel during a logical channel prioritization procedure;
not resetting new data indicators for uplink hybrid automatic repeat request (HARQ) processes;
not cancelling any triggered buffer status reporting procedure;
not cancelling any triggered timing advance reporting procedure;
not cancelling any triggered recommended bit rate query procedure; or
not flushing soft buffers for downlink HARQ processes.

20. A method performed by a first base station (BS), the method comprising:
transmitting, to a second BS, a handover (HO) request message for handing over a user equipment (UE) served by a wireless network node from the first BS to the second BS together with the wireless network node; and
receiving, from the second BS, a HO request acknowledgement message in response to the HO request message.
